(19) United States
(12) Patent Application Publication
(10) Pub. No.: US 2009/0156155 A1
(43) Pub. Date: Jun. 18, 2009

(54) RECEIVER, TUNER AND METHOD OF PROCESSING A TELEVISION SIGNAL

(75) Inventors: Erwin Krug, Munchen (DE); Claus Muschallik, Singapore (SG); Lars Persson, Grafing (DE)

Correspondence Address: ESCHWEILER & ASSOCIATES LLC, 629 EUCLID AVENUE, SUITE 1000, NATIONAL CITY BUILDING, CLEVELAND, OH, 44114, US

(73) Assignee: Infineon Technologies AG, Neubiberg (DE)

(21) Appl. No.: 11/957,819

(22) Filed: Dec. 17, 2007

(51) Int. Cl. H04B 1/26

(52) U.S. Cl. 455/313

(57) ABSTRACT

The invention is related to a receiver and a tuner respectively, particularly to a television receiver or tuner which can be integrated in a single circuit device. The invention is also related to a method for processing RF signal.

### FIELD OF THE INVENTION

The present invention is related to a receiver and a tuner, respectively, particularly to a television receiver or tuner which can be integrated in a single circuit device. The invention is also related to a method for processing an RF signal, e.g., a television signal.

### BACKGROUND

In consumer electronic devices, the capability of receiving an RF signal is becoming increasingly important. Such RF signal may include a television signal, a radio signal, a data communication signal like a Bluetooth or WLAN signal or a telecommunication signal. Television signals, for example, can be received by many devices. For instance, while stand-alone television sets can still be found in most households, the share of personal computer systems with television expansion cards or, generally, with television capabilities is recently increasing. In addition, there is an increasing demand by the consumer to combine telecommunication capabilities together with television and internet capabilities into a single product.

An element which can be found in most television applications is the television tuner capable of receiving a television signal and converting the received signal to a second frequency for further processing. Television tuners may comprise two basic components. The first component converts a received television signal to an intermediate frequency signal. The frequency converted signal may be supplied to the second component performing a further frequency conversion from the intermediate signal to a second intermediate signal. While for stand-alone television sets, the tuner may comprise several discrete elements like, for instance, inductors, capacitors and/or transistors, the demand for multi-media consumer electronics requires an increasing share of integrated circuitry without external discrete elements. Accordingly, there is a desire to reduce the size and elements of television tuners, preferably integrating a television tuner in a multi-purpose integrated circuit.

### SUMMARY

In an embodiment, a receiver comprises a receiver input configured to couple to an RF signal source. A first mixer device is coupled to that receiver input and is configured to convert an RF signal to a first signal at a first operating intermediate frequency. A second mixer device is coupled to the first mixer device and is configured to convert the first signal to a second signal on a second operating intermediate frequency. The first mixer device or the second mixer device may comprise a harmonic rejection mixer.

In one embodiment, the harmonic rejection mixer may reduce an undesired frequency conversion of harmonic signal portions to the first or second intermediate signal. It may also reduce the generation of signal portions in the first or second intermediate signal, wherein the signal portions comprise portions of the input signal converted by a local oscillator signal at harmonic frequencies. This may increase the signal quality of a received signal converted for further processing due to the fact that many unwanted signals lie within the received frequency range. In addition, a harmonic rejection mixer may relax the requirements of a filter arranged between the first and the second mixer.

### BRIEF DESCRIPTION OF THE DRAWINGS

For a more complete understanding of the present invention and the several aspects and advantages of the different embodiments thereof, reference is now made to the following descriptions taken in conjunction with the accompanying drawings in which

FIG. 1 illustrates a first embodiment of a tuner,

FIG. 2 shows a second embodiment of a tuner,

FIG. 3A shows a frequency diagram to illustrate the frequency conversion process in an up-down tuner according to the embodiment of FIG. 2

FIG. 3B shows a frequency diagram to illustrate the frequency conversion process in a tuner according to the embodiment of FIG. 1,

FIG. 4 illustrates a first embodiment of a harmonic rejection mixer,

FIG. 5 shows a second embodiment of a harmonic rejection mixer,

FIG. 6 illustrates an embodiment of a low noise amplifier in a television tuner,

FIG. 7 shows an embodiment for a frequency divider to provide local oscillator signals for a harmonic rejection mixer,

FIG. 8 shows an embodiment of an image rejection mixer,

FIG. 9 shows an embodiment of a conventional television tuner,

FIG. 10 shows a diagram illustrating a frequency response of a LC-filter, which may be implemented in a television tuner according to one or more embodiments,

FIG. 11 illustrates an embodiment of a method of the invention,

FIG. 12 shows a diagram illustrating a frequency response of a SAW-filter, which may be implemented in a television tuner, and

FIG. 13 illustrates an embodiment of the method.

### DETAILED DESCRIPTION

In the following description, aspects and embodiments of the present invention are disclosed. In addition, reference is made to the accompanying drawings which form a part hereof, and in which is shown by way of illustration in which the invention may be practiced. The embodiments of the drawings present a discussion in order to provide better understanding of one or more aspects of the present invention. The disclosure is not intended to limit the feature or key elements of the invention to a specific embodiment. Rather, the different elements, aspects, and features disclosed in the several embodiments can be combined in different ways by a person skilled in the art to achieve one or more advantages of the invention. It is to be understood that other embodiments may be utilized and structural or logical changes may be made without departing from the scope. The elements of the drawings are not necessarily to scale relative to each other. For illustration purposes, some frequency ranges and intermediate frequencies are specified. These ranges as well as the several discrete values are not restricted to the embodiments disclosed therein. A person skilled in the art may also use other frequency ranges, data transmission standards or discrete frequencies to achieve the different aspects of the present invention. Like reference numerals designate corresponding similar parts.

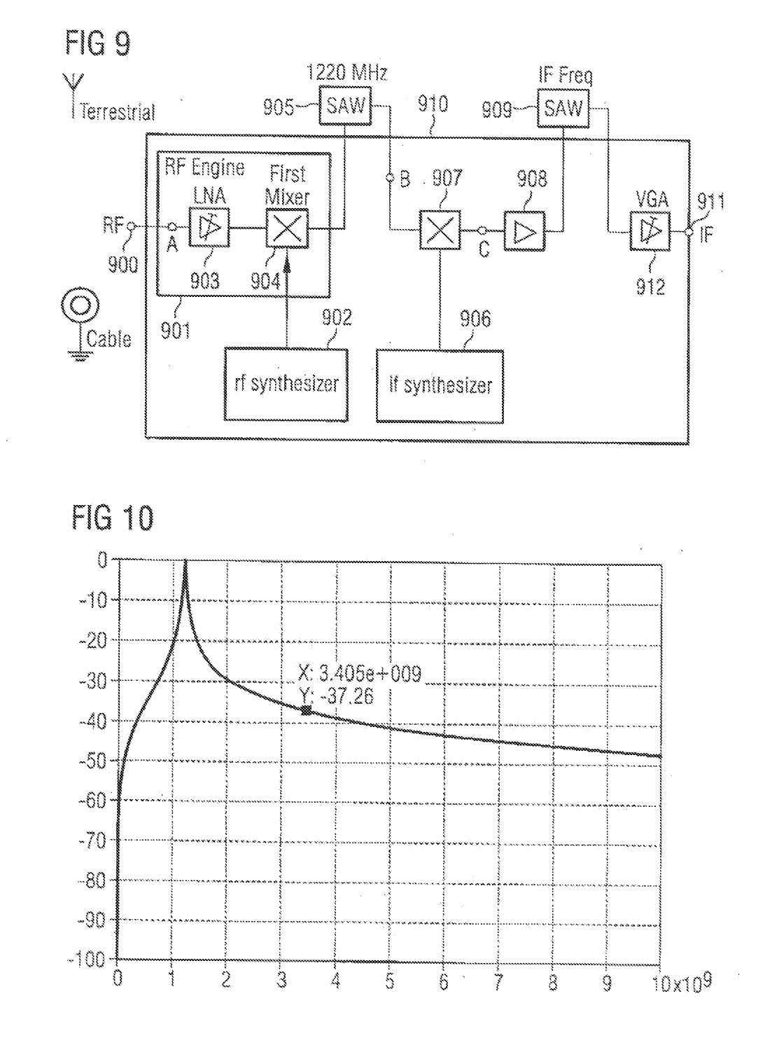

FIG. 9 shows an embodiment of a tuner 910 that converts an RF signal at terminal 900 into an intermediate or IF signal at terminal 911 for further processing. In this non-limiting embodiment the tuner 910 is configured to receive and process television signals. It will be appreciated that such tuners can nevertheless be used to receive signals for other applications and/or standards as well. The tuner 910 is also called an up-down converter due to its behavior of converting a received RF signal in a first step to a higher frequency range and in a subsequent conversion process to a second frequency range, lower than the range of the received RF signal. The tuner 910 comprises an input terminal 900 onto which an RF signal within the television frequency range can be applied. In one embodiment, the terminal can be connected to an antenna or to a network cable. The tuner may receive terrestrial or satellite television signals via the antenna or the cable. In this embodiment, the television frequency range starts from about 40 MHz up to roughly 1 GHz.

The input terminal 900 is connected to an RF engine device 901 comprising a low noise amplifier 903 with an adjustable gain connected to a first mixer 904. An LO input terminal of the first mixer 904 is connected to a first RF synthesizer 902 to receive a first local oscillator signal. In one embodiment, the first RF synthesizer 902 comprises a phase locked loop (not shown herein for illustration purposes) with an adjustable frequency divider in a feedback path. With the adjustable frequency divider, the RF synthesizer 902 is able to provide a local oscillator signal with a variable frequency. Thus, the first mixer 904 converts the RF signal at its input terminal using the variable local oscillator signal to a first intermediate signal with a fixed center frequency. In this embodiment, the local oscillator signal provided by the RF synthesizer 902 is selected such to convert the RF signal at the input terminal of the first mixer to a first intermediate signal with a center frequency of e.g. 1220 MHz.

The output of the first mixer 904 is connected to a SAW-filter 905 having a pass-band center frequency of e.g. 1220 MHz. The SAW-filter 905 is arranged in one embodiment as a discrete and external device due to the requirement of adjusting the filter parameters after manufacturing the tuner. The SAW-filter 905 comprises very steep edges and high filter suppression outside the pass-band area. The pass-band itself may range up to several MHz, depending on a bandwidth of the first intermediate signal. The output of the SAW-filter is connected to a second mixer 907 of the television tuner. The local oscillator input of the second mixer 907 is coupled to an IF synthesizer 906. The IF synthesizer may provide a signal with a center frequency of e.g. 1180 MHz, thereby converting the first intermediate signal at the input of the second mixer 907 to second intermediate signal at a second frequency, in this example 40 MHz. It should be noted that a signal provided by the IF synthesizer with a center frequency similar to the center frequency of the first intermediate signal may be used to convert the first intermediate signal to zero frequency, which is sometimes called baseband.

The output of the second mixer 907 is connected to a first amplifier 908 and a second IF-filter 909. In this embodiment, the second filter 909 comprises an externally arranged SAW-filter. The output of the SAW-filter 909 is coupled to a variable gain amplifier 912 of the television tuner 910. Finally, the amplified intermediate signal is provided at the output terminal 911.

As illustrated in the non-limiting embodiment of FIG. 9, the two filter elements 905 and 909 are arranged externally and implemented using SAW-filters. SAW-filters normally comprise a bandwidth depending on the desired bandwidth, for instance approximately 20 MHz. While the steep edges on the pass-band of the SAW-filters allow roughly only one unwanted channel on each side of the wanted carrier to get through the filter without additional attenuation, they are able to suppress unwanted signals in the second or further adjacent channels.

FIG. 12 shows a diagram illustrating the attenuation vs. frequency of a SAW-filter with a pass-band center at around 1220 MHz. The edges of the shown attenuation behavior are very steep, suppressing for instance any unwanted signal at 2 GHz by roughly 50 dB. The pass-band itself is very small in the range of about 20 MHz in one embodiment. Such steep edges and high suppression outside the pass-band are desirable due to the fact that unwanted signal portions of a received television RF signal have sometimes more power than the respective signal in the desired channel. Due to the frequency conversion process in the first mixer, such undesired signal portions may generate intermodulation products. In addition, the output signal of the RF synthesizer 902 as well as the RF synthesizer 906 may comprise additional signal portions at harmonic frequencies of the local oscillator frequency. Applying such harmonic signal portions to the mixer will result undesirable in a converted received signal to an undesired frequency range.

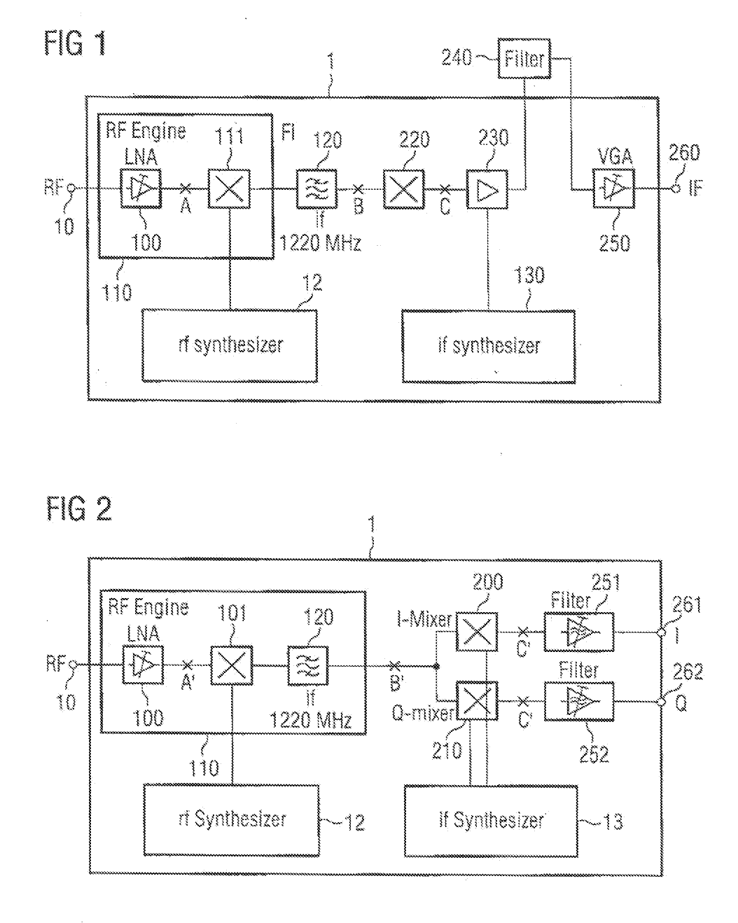

FIG. 1 shows an improved tuner 1 suppressing frequency conversion of unwanted signal portions. The tuner 1 can be used to receive any kind of signals, including television signals. Hence, the structure is not limited to any specific application.

The tuner 1 is implemented in one embodiment as an integrated circuit in a semiconductor chip requiring less chip area and comprising no discrete elements. The tuner 1 comprises an RF engine 110 connected to the RF input terminal 10. An RF signal applied to the input terminal 10 is amplified by a low noise amplifier 100 and provided at a first mixer 111 being part of the RF engine 110. In this embodiment, the first mixer 111 is implemented as a harmonic rejection mixer that is configured to suppress harmonic portions of a local oscillator signal during conversion.

The mixer 111 comprises a local oscillator input connected to an RF synthesizer 12. Its output is connected to a first IF bandpass filter 120 with a pass-band center frequency of 1220 MHz, in one embodiment. Due to the harmonic mixer the filter requirements are relaxed and a non-SAW-filter type can be used and implemented at least partly internally in the tuner 1. Filter 120 may comprise a passive filter of first, second or a higher order, in one embodiment. It may comprise one or more capacitors, inductors and/or resistors. It may also comprise an active filter with transistors or other active elements. Combinations of passive and active elements are also possible. The output terminal of the filter 120 is connected to a second IF mixer 220 having a signal input, a local oscillator input and a signal output. The local oscillator signal for the second mixer 220 is provided by the IF synthesizer 130. An output terminal of the second mixer 220 is connected to an amplifier 230 coupled to a second filter 240. The output of the filter 240 is connected to an internally arranged variable gain amplifier 250. While in this embodiment the second filter 240 is arranged externally, the filter may also implemented at least partly within the tuner 1 as an integrated sub-circuit thereof.

The second mixer 220 may comprise a normal mixer, an image rejection mixer, a harmonic rejection mixer, or a combination thereof. For instance, an image rejection mixer with harmonic rejection can be used as mixer 220. Due to the harmonic rejection of the first mixer 111 and/or the second mixer 220, the requirements concerning the first bandpass filter 120 are reduced. Signal quality at the output terminal 260 can be further improved by the second mixer implemented, for example, as an image rejection mixer which suppresses any unwanted image generated during conversion.

Implementing the second mixer 220 as a harmonic rejection mixer results in suppressing unwanted harmonic portions of the second local oscillator signal provided by the IF synthesizer 130. Accordingly, the use of a harmonic rejection mixer as the first mixer 111 or the second mixer 220 reduces the requirements of the first filter 120, thereby allowing the first bandpass filter 120 to be implemented within the tuner 1. In addition, the linearity requirements of the amplifier 230 are relaxed. This may reduce the overall required space and renders manual matching or calibration of an externally arranged filter unnecessary.

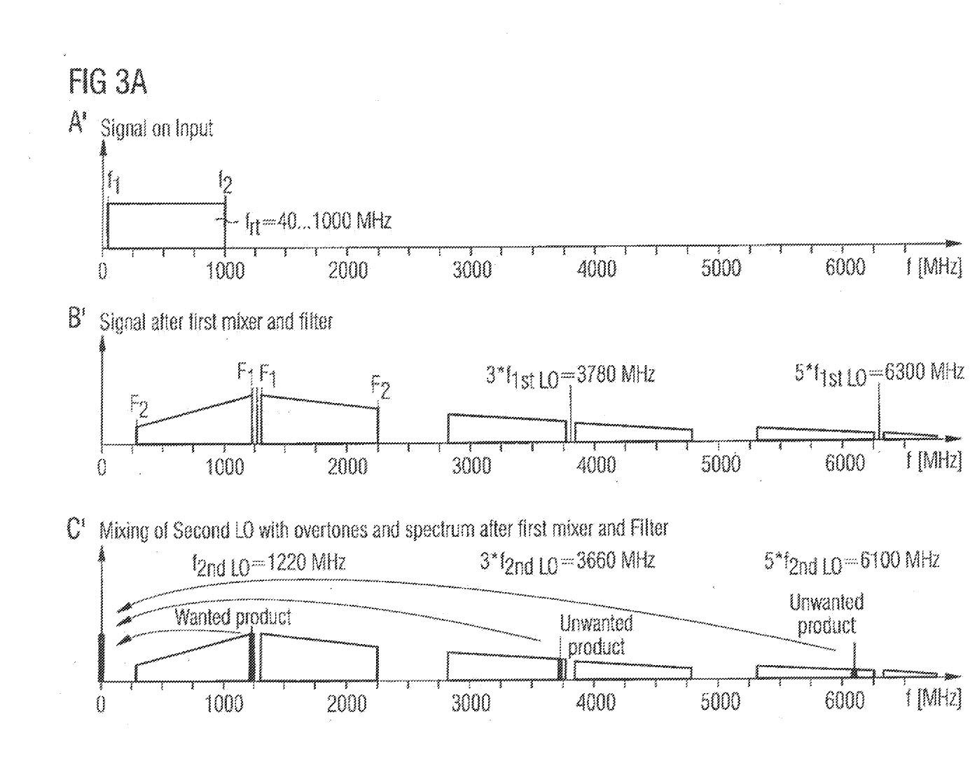

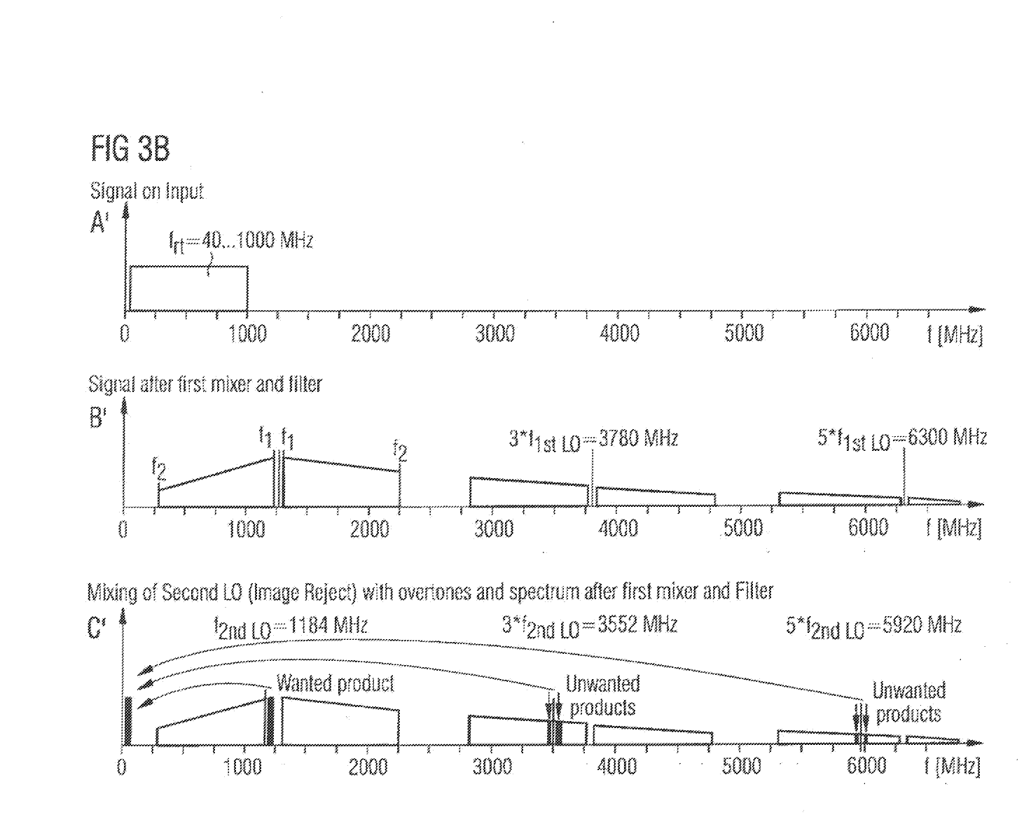

FIG. 3B shows several frequency diagrams illustrating the complexity for signal conversion with an up/down signal according to the embodiment of FIG. 1. As illustrated in diagram A, corresponding to point A in FIG. 1, the frequency of the RF input signal at terminal 900 ranges from approximately 40 MHz to 1000 MHz. When converting the received RF signal in the first mixer 904 with a local oscillator signal having a frequency of LO1=1260 MHz, for example, the input RF signal is converted to 1220 MHz down to 260 MHz as indicated by the edge frequencies f₁, f₂. An image is generated ranging from 1300 MHz up to 2260 MHz. Such conversion with a first intermediate signal at frequencies f_{IF} can be expressed by:

f_{IF}=f_{LO}±f_{RF}

Due to the harmonic portions of the local oscillator signal, additional frequency conversions are performed using the third harmonic portion at 3*f_{1stLO}=3780 MHz as well as the fifth harmonic portion at 5*f_{1stLO}=6300 MHz.

Diagram B showing the desired conversion process as well the conversion using the harmonic portions corresponds to point B in FIG. 1. The amplitude of the converted signals by the third and the fifth harmonic portion are significantly suppressed due to a harmonic rejection behavior in the first mixer. Additional filtering is supplied resulting in further suppression at higher frequencies. As illustrated, the image portion at higher frequencies comprises a still lower amplitude compared to the respective portions at lower frequencies. This behavior resembles the filter response of an LC-filter as illustrated in FIG. 10 that can be integrated with the first mixer in an integrated circuit.

Diagram C, corresponding to point C of FIG. 1 shows the frequency conversion using the IF synthesizer signal at 1184 MHz as an LO-signal, thereby performing a frequency conversion down to 36 MHz. If the second local oscillator signal applied to the second mixer also comprises a third and fifth harmonic as indicated in diagram C, signal portions of the previous up-converted portions may also converted, resulting in unwanted products. The same applies for the image portion as indicated. Nevertheless, the harmonic rejection already suppresses significantly any signal down-conversion caused by the third and fifth harmonic due to the suppression of the harmonic portion itself. Consequently, the conversion bands in diagram B at approximately 2800 MHz up to 6600 MHz are already much lower than the desired signal. By applying additional filtering the undesired signal portions are further suppressed. As a result, only a small amount of energy in the unwanted product is converted down to the second intermediate signal at the second intermediate frequency. In addition, a harmonic rejection mixer and/or an image rejection mixer can be used for the second conversion process.

FIG. 2 shows a further embodiment of an improved television tuner. The tuner 1 implemented in a semiconductor chip as an integrated circuit comprises an RF synthesizer 12 and an IF synthesizer 13.

While the RF synthesizer 12 generates a first local oscillator signal having a variable frequency, the second IF synthesizer 13 produces two signals with substantially constant frequency and a phase shift of 90° in-between.

The frequency of the two signals generated can be chosen to be equal to a center frequency of the first intermediate signal provided by the first mixer 111 in one embodiment. In a frequency conversion process, the first intermediate signal will be converted to zero frequency using the two signals as local oscillator signals in one embodiment. The two signals are applied to two separate mixers 200, 210 forming an IQ-demodulator. Each mixer 200, 210 may be implemented as single-side band mixers or as harmonic rejection mixers.

The respective signal input of mixers 200, 210 are connected to an output terminal of an RF engine 11 comprising a low noise amplifier 100, a first mixer 101 and a bandpass filter 120 with a pass-band center frequency in the range of 1220 MHz. The first mixer 101 of the RF engine 11 comprises a local oscillator input connected to the RF synthesizer 12. In one embodiment, the first mixer 101 is implemented as a harmonic rejection mixer suppressing any harmonic portion, in particular the third and fifth harmonic of the RF synthesizer 12.

In an alternative embodiment, the first mixer 101 can be implemented as a normal mixer or an image rejection mixer while the I- and Q-mixers 200 and 210 are then realized as harmonic rejection mixers. In yet another embodiment, the first mixer 101 may be implemented as a harmonic rejection mixer with additional image rejection. A single-sideband mixer with harmonic rejection may also be used. In either case, the frequency conversion of spurious signals using harmonic portions of a local oscillator signal is suppressed, thereby increasing signal quality.

The output of the respective I-and Q-mixers 200, 210 are coupled to filters and variable gain amplifiers 251 and 252, respectively. Each filter and amplifier 251, 252 comprises a lowpass or bandpass filter configured to suppress spurious and harmonic or sub-harmonic signal portions of the converted I- and Q-signals. They further may comprise a variable gain amplifier to adjust the amplitude of the corresponding frequency converted I- and Q-signals. The respective I- and Q-signals are provided at the output terminals 261 and 262 of the television tuner.

FIG. 3A illustrates several frequency diagrams showing the signal conversion with an up/down signal according to the embodiment of FIG. 2. The frequency of the RF input signal at terminal 900 ranges from approximately 40 MHz to 1000 MHz as indicated in diagram A′ corresponding to A′ in FIG. 1. Again, additional filtering is applied after the first conversion. For this purpose, a normal LC filter can be used in one embodiment. The frequency response of such filter can be seen in FIG. 10. The filter comprises a suppression of approximately 30 to 40 dB at some 100 MHz distance from the pass-band center frequency. The slope of the frequency response is similar to the slope of the unwanted portions in diagram B′. The suppression of a LC filter is sufficient, if harmonic rejection mixers are used as the first and/or as second mixer. After the second conversion process down to a baseband signal with a second local oscillator signal at 1220 MHz, the energy portions of unwanted signals also converted are too small to distort the converted signal and decrease the quality significantly.

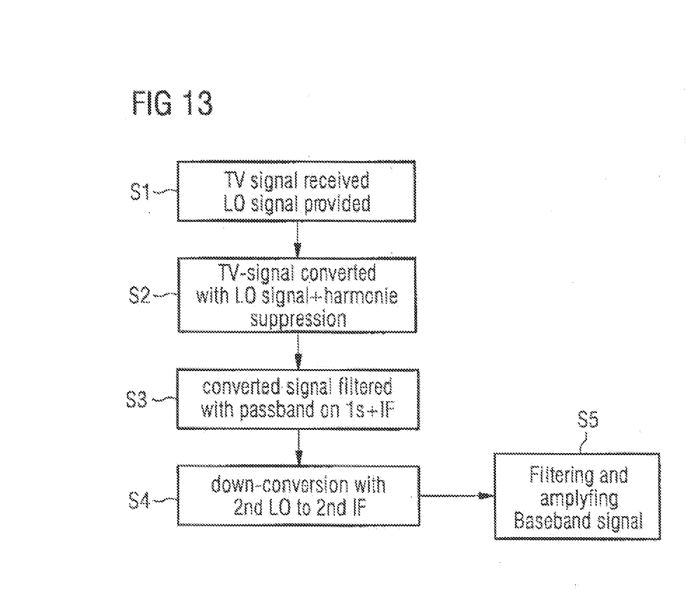

FIG. 13 illustrates a further embodiment of a tuner device 1. The tuner is implemented as a partly integrated circuit in a semiconductor substrate. The semiconductor material may comprise silicon or gallium-arsenide for example. The tuner comprises a harmonic rejection mixer 101 coupled to the RF input terminal 10 on a surface of the semiconductor substrate. Output terminals 261 and 262 for I and Q baseband signals are also arranged on the surface of the substrate. The I and Q signals may be analog signals or digital signals. For instance, the elements 250 and 252 in the tuner 1 may comprise filters and analog to digital converters as well.

In this embodiment, a bandpass LC-filter 120a is arranged between the first harmonic rejection mixer 101 and the mixers 200 and 210 respectively, which are implemented as harmonic rejection mixers as well. The LC-filter 120a comprises a circuit of two adjustable capacitors C connected in parallel to two inductors L. A node between the two inductors L is connected to a supply terminal VCC. In one embodiment, the LC-filter 120a is only partly implemented in the semiconductor substrate. In detail, in one embodiment, the inductors L are realized outside the substrate. Such inductors can be implemented, for instance, using bond wires or similar means to couple both adjustable capacitors within the semiconductor substrate to the external terminal VCC.

Generally, an integrated tuner may comprise a low noise amplifier to amplify a received signal applied to an input terminal, and an up-down frequency converter connected to the low noise amplifier to convert the received signal to an intermediate signal. The up-down frequency converter comprises a first mixer stage to up-convert the received signal and a second mixer stage to down-convert a previous up-converted signal. At least one of the first and second mixer stages comprises a harmonic rejection mixer that is configured to suppress harmonic portions in a local oscillator signal applied thereto.

In a further embodiment, the first mixer device may comprise the harmonic rejection mixer and the second mixer device may comprise an image rejection mixer. Performing a harmonic rejection in the first mixer device reduces the linearity requirements of the second mixer device because the total amount of energy in the first intermediate signal is reduced. In another embodiment, the second mixer device is an image rejection mixer with harmonic rejection.

The receiver may further comprise a first signal source to provide a first local oscillator signal having a variable frequency, the first signal source coupled to the first mixer device. A signal source providing a signal with a variable frequency allows performing a frequency conversion of an RF signal to a first intermediate signal to a fixed first operating frequency.

Accordingly, a television signal on an RF frequency in a specific range can be converted by the first mixer with the first mixer source to a first intermediate signal to a constant or variable intermediate frequency. Such mixing can be performed substractively or additively. Together with a harmonic rejection in the first mixer, any harmonic spurious signal portions in the first local oscillator signal of the first signal source may be reduced.

The television receiver may also comprise a second signal source to provide a second local oscillator signal on the first operating frequency. The second signal source may be coupled to the second mixer device, thereby performing a frequency conversion of the first intermediate signal to a second intermediate signal in the baseband. The second mixer may comprise a harmonic rejection mixer to prevent conversion of the first intermediate signal with harmonic signal portions of the second local oscillator signal.

If the frequency of the second local oscillator signal is equal or similar to the first operating frequency, one may talk of a zero frequency conversion. It may be useful to convert the RF signal to a first intermediate signal on the first operating frequency, whereby the first operating frequency is higher than the RF signal, thereby performing an up-conversion. This may reduce spurious signal portions in the received RF signal.

The second mixer device may also comprise an IQ demodulator device, thereby converting the first intermediate signal into an I- and a Q-signal component in the baseband. The IQ-demodulator may comprise two normal mixers or harmonic rejection mixers.

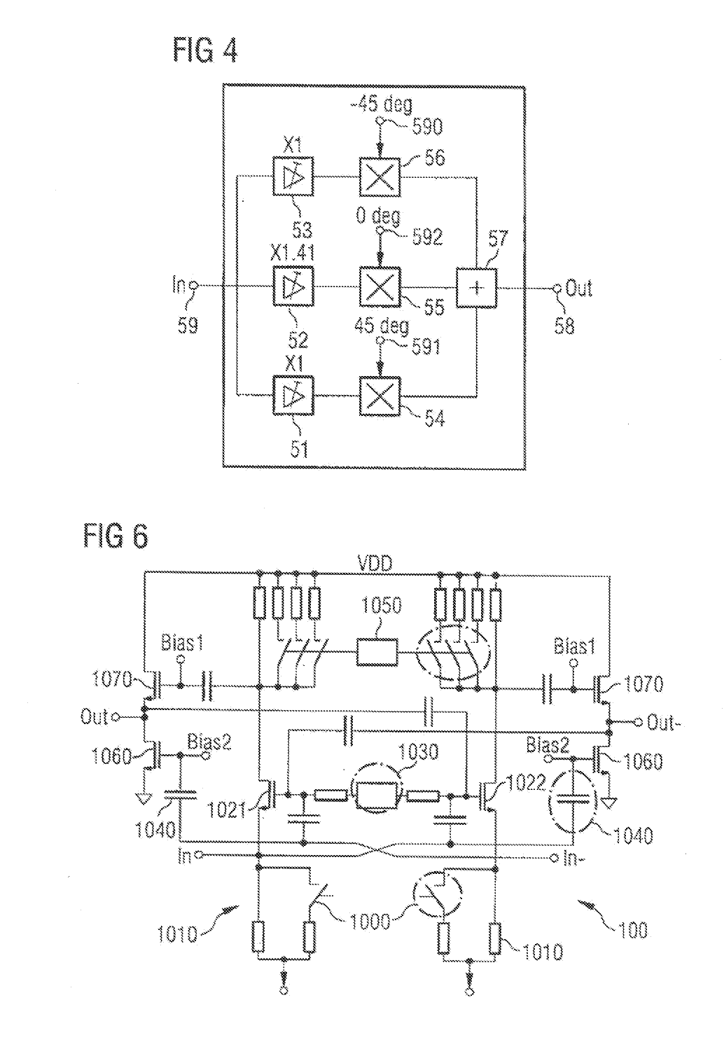

One embodiment of a harmonic rejection mixer is illustrated in FIG. 4. The harmonic rejection mixer 50 comprises an input terminal 59 for an input signal and an output terminal 58 for the frequency converted signal. In this embodiment, any input signal is provided to three different amplifier elements 51, 52 and 53, two of them amplifying the signal by the same factor X*1 and a third amplifying the signal by a factor of X*1.41.

Particularly, the amplifiers 51 and 53 are amplifying the signal with the same gain factor while the amplifier 52 is amplifying the input signal applied to terminal 59 by an additional gain factor of 1.41. The output terminals of the first and third amplifier 52 and 53 are connected to respective mixer 54, 56. The output of the third amplifier 52 is coupled to a third mixer 55. Each of the mixers 54 to 56 comprises a local oscillator input terminal for applying a local oscillator signal. The local oscillator signal of the first mixer 54 has a phase shift of +45° with respect to the local oscillator signal at the third mixer 55. Accordingly, the local oscillator signal at terminal 590 for the second mixer 56 comprises a phase shift of approximately −45° with respect to the local oscillator signal at terminal 592. The output of each of the respective mixers are summed up in element 57 and provided at output terminal 58.

An aspect of a harmonic rejection mixer is to multiply the signal to be converted by, for instance, an amplitude-quantized sinusoid signal f_{LO}(t). The signal f_{LO}(t) is given by

f_{LO}(t)=\sqrt{2}f₂(t)+f₁(t)+f₃(t) (1)

wherein the magnitude of f₂(t) is scaled by a factor of \sqrt{2} to better represent a quantized sinusoid signal. In order to better understand the rejection of the first and fifth harmonic, it is instructive to expand to three square waves using a Fourier series. The representation of the three square waves up to the fifth order component is given by

$$\begin{matrix}{f}_{1} ( t ) = \frac{\sqrt{2}}{π} [ \begin{matrix}( cos ( ω t ) - sin ( ω t ) ) + \frac{1}{3} ( cos ( 3 ω t ) + sin ( 3 ω t ) ) - \\ \frac{1}{5} ( cos ( 5 ω t ) - sin ( 5 ω t ) ) …\end{matrix} ] & ( 2 ) \\ {f}_{2} ( t ) = \frac{2}{π} [ cos ( ω t ) - \frac{1}{3} cos ( 3 ω t ) + \frac{1}{5} cos ( 5 ω t ) … ] & ( 3 ) \\ {f}_{3} ( t ) = \frac{\sqrt{2}}{π} [ \begin{matrix}( cos ( ω t ) + sin ( ω t ) ) + \frac{1}{3} ( cos ( 3 ω t ) - sin ( 3 ω t ) ) - \\ \frac{1}{5} ( cos ( 5 ω t ) + sin ( 5 ω t ) ) …\end{matrix} ] & ( 4 )\end{matrix}$$

Summing the three ideal square waves as explained in formula (1) results in a total rejection of the third and fifth harmonic. However, as can be seen from formulas

$$H R {M}_{3} = ( \frac{1}{9} ) ( {( 1 - cos ( 3 θ ) ( 1 + Δ ) )}^{2} + ( ( 1 + Δ ) sin ( 3 θ ) ) )$$

$$H R {M}_{5} = ( \frac{1}{25} ) ( {( 1 - cos ( 5 θ ) ( 1 + Δ ) )}^{2} + ( ( 1 + Δ ) sin ( 5 θ ) ) )$$

The suppression is strongly dependent on the gain mismatch (Δ) and the phase mismatch (Φ) similar to single-sideband mixing.

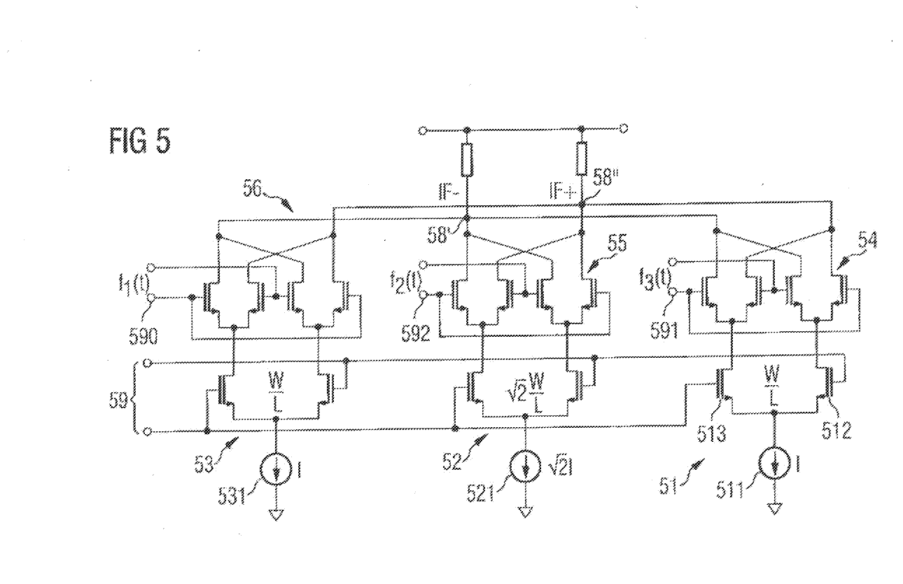

FIG. 5 shows an implementation of a harmonic rejection mixer for an input signal at terminal 59 and three mixers with different local oscillator signals f₁(t) to f₃(t).

The harmonic rejection mixer according to the embodiment in FIG. 5 is a balanced mixer comprising three Gilbert cells 54 to 56 as mixers. Each of the cells 54 to 56 comprise a pair of field effect transistors coupled with their gate terminals to the respective input terminals for the corresponding local oscillator signal. A drain terminal of one of the transistor pairs is connected to the respective other drain terminal of the other pair implementing a cross-coupling. The respective source terminals of each pair are connected to the respective amplifier 51 to 53. The amplifiers 51 to 53 comprise a pair of field effect transistors each of them coupled with its gate terminal to the respective input terminal 59 for the balanced input signal. The transistors in the amplifiers 51 to 53 comprise a gate length L and a gate width W. The ratio W/L corresponds to the gain factor as indicated in FIG. 4. Consequently, the ratio W/L of the transistors in the amplifier 52 is about 1.41 times higher than the corresponding ratio W/L of the first and second amplifier 51 and 53. Hence, amplifier 52 has a higher gain factor as required in the aforementioned explanation.

Additionally, the source terminals of the respective transistors in the amplifiers 51, 52 and 53 are connected to a current source 511 to 531. While the current sources 511 and 531 provide the current I, the current source 521 for the third amplifier 52 provides a current 1.41 times higher than the current I of the other two current sources.

Finally, the output of the Gilbert cells are connected together to add up the signals and provide the signals at the corresponding outputs 58′ and 58″.

Since a phase mismatch between the local oscillator signals is of relevance for a harmonic suppression, the local oscillator signals f₁(t) to f₃(t) should be derived from a single clock signal.

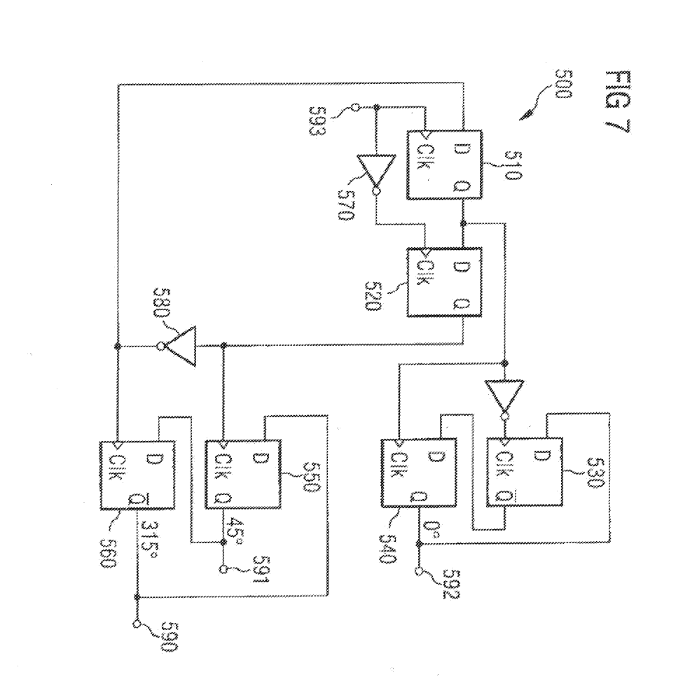

FIG. 7 illustrates an embodiment of a frequency divider circuit providing three signals having the required phase shift in between. In this embodiment, the frequency of a clock signal, which comprises a good duty cycle, at terminal 593 is divided by a factor of 4 and three frequency divided signals are generated and provided at output terminals 590 to 592. Due to the frequency division, the signals also comprise a phase shift to each other as indicated in FIG. 7. It should be noted that a phase shift of 315° with respect to a signal with 0° phase shift is equivalent to a phase shift of approximately −45°.

In the frequency divider, the input terminal 593 is coupled to clock terminals of respective D-flip-flops 510, 520. Particularly, the terminal 593 is connected directly to the clock terminal of D-flip-flop 510 and coupled via an inverter 570 to the clock terminal of D-flip-flop 520. The data output Q of the first D-flip-flop 510 is connected to the data input D of D-flip-flop 520. The data output Q of D-flip-flop 520 is coupled via a second inverter 580 to the data input D of the first D-flip-flop 510. The two D-flip-flops 510 and 520 represent a first frequency divider with a division factor of 2.

The phase shift between the output signals at data output Q of both D-flip-flops comprises 90° to each other.

In this exemplary embodiment, the D-flip-flop circuits 510 and 520 do not comprise an additional data output Q′ for an inverted output signal. Still, in an alternative embodiment it is possible to couple an additional inverted data output Q′ of D-flip-flop 520 to the data input of the first D-flip-flop 510.

Two additional pairs of D-flip-flops 530, 540 and 550, 560 are coupled to the data outputs Q of the first pair. Particularly, the data output Q of D-flip-flop 520 is coupled to the clock input of D-flip-flop 550 and via a second inverter 580 to clock input terminal of D-flip-flop 560. The data output Q of the first D-flip-flop 510 is connected directly to clock terminal of D-flip-flop 540 of the second pair of D-flip-flops and via an inverter to a clock terminal of D-flip-flop 530. While the data output Q of the second D-flip-flop 540 of the second pair is connected to the output terminal 592 and to the data input D of D-flip-flop 530 of the second additional flip-flop pair, the inverted data output Q̅ of D-flip-flop 530 is connected to the data input D of D-flip-flop 540. In a similar manner, the third pair of D-flip-flops with circuits 550 and 560 is connected together. Particularly, the data input D of the D-flip-flop 550 is coupled to the output terminal 590 and to the inverted data output Q̅ of D-flip-flop 560 to receive an inverted output signal. The data output Q of D-flip-flop 550 provides a signal for output terminal 591 and is also connected to data input D of D-flip-flop 560.

As indicated in FIG. 7, the D-flip-flop 540 provides a frequency divided signal at terminal 592 with a zero phase shift with respect to the signal at output terminals 590 and 591, respectively. While the D-flip-flop 550 generates a frequency divided signal of substantially +45° in respect to the output signal at terminal 592, the D-flip-flop 560 provides a signal with 315° phase shift. This phase shift corresponds to substantially −45° with respect to the signal at terminal 592. Accordingly, the phase shift between the output terminals 590 and 591 is 90°.

The output terminals 590 to 592 providing a balanced output signal are connected to the corresponding terminals of the harmonic rejection mixer according to FIG. 5. It should be noted that other data outputs of D-flip-flop 530 to 560 can be used as well as long as the phase shift between the output terminals is approximately +45° and approximately −45° in respect to one output signal.

The received RF signal can be much smaller with respect to an adjacent spurious signal. For instance, an unwanted signal in an adjacent channel can be up to approximately 60 dB stronger than the desired television signal. To improve the situation a bandpass filter can be arranged between the antenna and a first amplifier or between the input terminal of the tuner and an amplifier within the tuner.

Nevertheless, the received RF signal has to be amplified by a low noise amplifier, ensuring only a low noise figure to be added to the received signal. FIG. 6 shows an embodiment of a low noise amplifier implemented as a fully differential amplifier. The amplifier can be implemented as amplifier 100 in the embodiments according to FIGS. 1 and 2.

The low noise amplifier comprises two stages wherein the first stage is based on a common-source/common-gate architecture. Its common mode output is regulated for a good linearity for each gain by a feedback loop. The second stage of the low noise amplifier is a source follower that performs an impedance matching. With the embodiment according to FIG. 6, it is possible to cover the whole input band of roughly 1 GHz for a received RF input signal.

The low noise amplifier 100 comprises a current source 1010 having a switch for a bypass mode. The input terminals In+, In− are connected to respective capacitors connected to gates of corresponding transistors 1021 and 1022 and to capacitors 1040 for noise cancellation. In addition, the input terminal In− is coupled to the source of transistor 1022 and terminal In+ is coupled to source of transistor 1021. The respective second terminal of the capacitors 1040 are connected to corresponding gate terminals of impedance matching transistors 1060.

The gate terminal of transistor 1021 is further connected via a second capacitor to the output terminal OUT−. Accordingly, the transistor 1022 is connected with its gate to a second capacitor and to output terminal OUT+. Additional common-mode transistors 1070 are connected with the drain terminals to the respective output terminals OUT-− and OUT+ and to a common source VDD. Their gates are connected to a bias voltage BIAS1 and via capacitors to a switching network for gain control. A control circuit 1050 provides corresponding control signals for gain adjustment by switching one or more resistors between the supply voltage terminal VDD and the drain terminals of transistors 1021 and 1022, respectively. For a low-gain mode, the first stage gain transistors 1021 and 1022 can be bypassed by element 1030 providing a bypass voltage via resistors to the respective gate terminals.

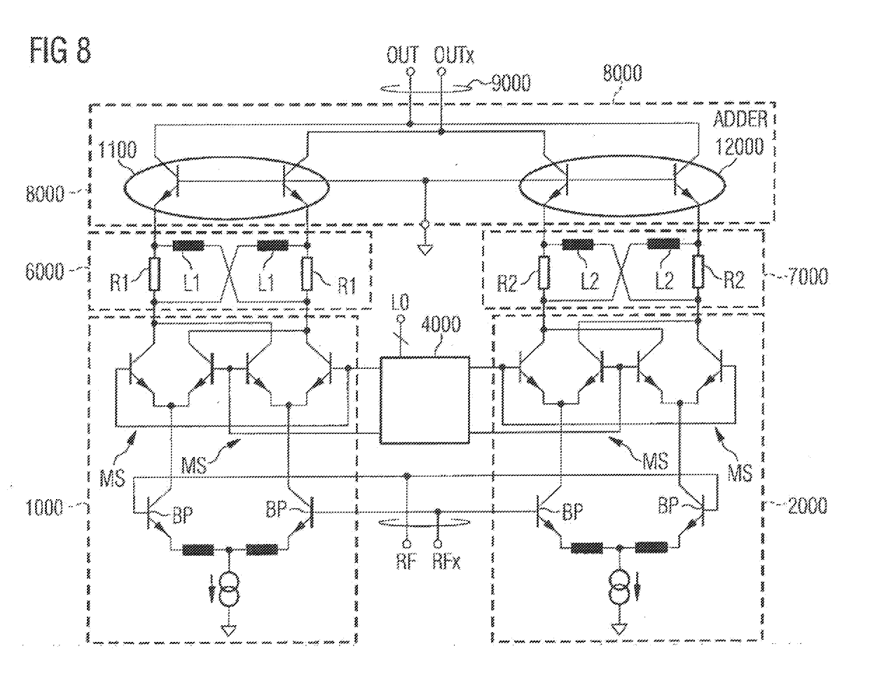

FIG. 8 shows an image rejection mixer which can be used as a first or second mixer in one of the television tuners described in FIGS. 1 or 2 in one embodiment of the invention.

The image rejection mixer is implemented as a fully differential image rejection mixer comprising two Gilbert cells 1000, 2000 coupled to respective current phase shifters 6000 and 7000 connected upstream to an adder 8000 with two output circuits 1100, 1200. In the embodiment, the Gilbert cell as well as the phase shifters and the output circuitry 1100, 1200 is implemented using bipolar transistors. Of course, field effect transistors can be used as well. Each Gilbert cell comprises two bipolar transistors BP connected with their emitters to a common current source and coupled with their connector terminals to the mixing stages MS. The bases of the bipolar transistor pairs BP are coupled to the input terminals RF and RFX. The mixing stages MS, each of them four comprising four bipolar transistors, are connected with two bases to a local phase shifter 4000 circuit providing signals with a phase shift of 90° in between. For instance, the signals provided by the phase shifters may comprise a substantially +45° or a substantially −45° phase shift in respect to a signal at input terminal LO.

For an image rejection of the frequency converted signal, the output terminals of each Gilbert cell 1000, 2000 are coupled to current phase shifter 6000, 7000, each comprising a pair of resistors R1, R2 in each signal path. Further, two inductors L1, L2 in each signal path connect one resistor terminal to the respective other terminal of the second resistor in the path representing a lattice circuit. The phase shifter 6000, 7000 shift the phase of the frequency converted current signals by “α” degrees using the lattice circuit having the inductors L and the resistors R.

In the adder circuitry (1100, 1200 connected downstream to the phase shifters 6000, 7000, the output signals of the phase shifters are added by the cascode transistors in the adder 8000, thereby subtracting the image portion of the frequency converted signals of both Gilbert cells from each other. The frequency converted and summed output signal is provided at terminals OUT, OUTx as a balanced output signal. Maximizing the current gain and affecting a phase shift of at degree can be achieved by making the output impedance of the phase shifter of current phase type 6000, 7000 or the input impedance of the adding circuit 8000 equal to 0. This can be achieved by determining values of the inductor L and the resistor R of the LR lattice circuit of the phase shifter 6000, 7000 so that the inductor L and the resistor R may satisfy the equation:

L1/R1=(1−cos α)/(2πf sin α)

L2/R2=(1−sin α)/(2πf cos α)

where f is the center frequency of the frequency converted signal.

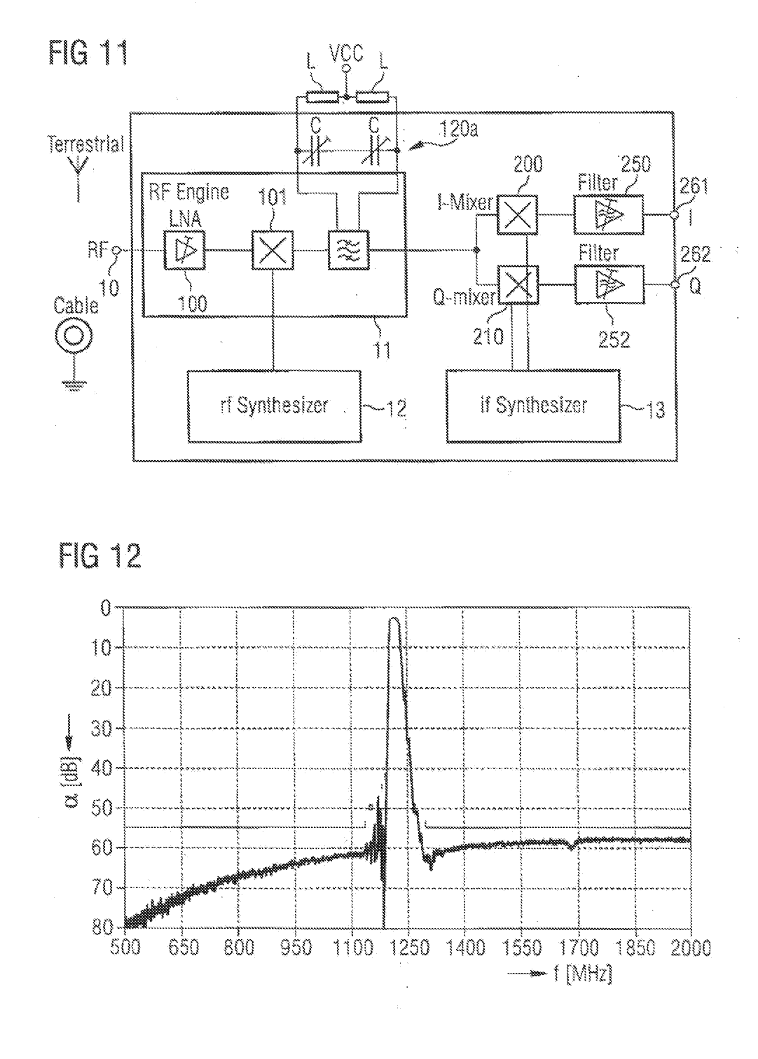

FIG. 11 shows an embodiment of a method for converting a television signal. While the exemplary method is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention.

In a first step S1, a television signal is received and a first local oscillator signal (LO) with an adjustable frequency is provided. The received signal is converted to a first intermediate signal on a first intermediate frequency in step S2.

During the conversion process harmonic of S2, portions in the local oscillator's signal as well as in the received signal may be suppressed. This can be achieved by providing a first signal having the adjustable frequency, a second signal having the adjustable frequency and a phase shift of substantially −45° with respect to the first signal and a third signal having the adjustable frequency and a phase shift of substantially +45° with respect to the first signal. For instance the step of providing an oscillator signal may comprise these three steps. In addition the received signal is amplified by a factor of approximately 1.41 and the converted using the first signal. Further the received signal is also converted with use of the second signal and the third signal. Finally, all the converted signals are summed together.

The converted signal is then filtered suppressing unwanted signals in adjacent channels in step S3. Then the filtered signal is converted again using a local oscillator signal at the first intermediate frequency to a second intermediate signal on a second frequency in step S4. Optionally as indicated in step S5 the now down-converted signal can be amplified and filtered again before further processing. While in this embodiment harmonic suppression is performed during the first conversion, harmonic suppression during the second conversion process is also possible.

The combination of an up/down converter in a television tuner together with a harmonic rejection mixer provides relaxed requirements for additional bandpass filtering as well as for the respective other mixer. Together with an additional image rejection and/or a second harmonic rejection mixer, an up/down converter improves the signal quality effectively and allows the implementation of a television receiver in an integrated circuit. Although specific embodiments have been illustrated and described, it will be appreciated by one of ordinary skill in the art that any arrangement which is calculated to achieve the same purpose may be substituted for the specific embodiment shown. It is to be understood that the above description is intended to be illustrative and not restrictive. The application is intended to cover any variations of the invention. The scope of the invention includes any other embodiments and applications in which the above structures and methods may be used. The scope of the invention should therefore be determined with reference to the appended claims along with the scope of equivalence to which such claims are entitled.

It is emphasized that the abstract is provided to comply with 37 CFR. Section 1.72(b) requiring an abstract that will allow the reader to quickly ascertain the nature and gist of a technical disclosure. It is submitted with the understanding that it will not be used to interpret or limit the scope of meaning of the claims.

1. A receiver, comprising:
a receiver input configured to receive an RF signal;
a first mixer device coupled to the receiver input and configured to convert the RF signal to a first intermediate signal at a first operating frequency;
a second mixer device coupled to the first mixer and configured to convert the first intermediate signal to a second intermediate signal at a second operating frequency;
wherein at least one of the first mixer device and the second mixer device comprises a harmonic rejection mixer.

2. The receiver of claim 1, further comprising:
a filter device having a pass-band center frequency at the first operating frequency and coupled with an input thereof to the first mixer device and with an output thereof to the second mixer device.

3. The receiver of claim 1, wherein the first mixer device comprises a harmonic rejection mixer and the second mixer device comprises an image rejection mixer.

4. The receiver of claim 1, wherein the second mixer device comprises an image rejection mixer with harmonic rejection.

5. The receiver of claim 1, further comprising a first signal source configured to provide a first local oscillator signal having a variable frequency, wherein the first signal source is coupled to the first mixer device.

6. The receiver of claim 5, wherein the first signal source is configured to provide three local oscillator signals, wherein a second signal of the three local oscillator signals comprises a phase shift of substantially +45° with respect to a first signal of the three local oscillator signals, and wherein a third signal of the three local oscillator signals comprises a phase shift of substantially −45° with respect to the first signal.

7. The receiver of claim 5, wherein the first mixer device is configured to subtractively mix the RF signal with the variable first local oscillator signal to generate the first intermediate signal at the first operating frequency.

8. The receiver of claim 1, further comprising a second signal source coupled to the second mixer device, wherein the second signal source is configured to provide a second local oscillator signal at the first operating frequency.

9. The receiver of claim 8, wherein the second signal source is configured to provide three local oscillator signals, wherein a first signal of the three local oscillator signals comprises a phase shift of substantially +45 degree with respect to a second signal of the three local oscillator signals, and wherein a third signal of the three local oscillator signals comprises a phase shift of substantially −45 degree with respect to the second signal.

10. The receiver of claim 1, wherein the second operating frequency is zero frequency.

11. The receiver of claim 1, wherein the second mixer device comprises an IQ-demodulator.

12. The receiver of claim 1, wherein the harmonic rejection mixer device comprises three mixer stages, each coupled to the input of the harmonic rejection mixer and configured to receive a respective local oscillator signal, wherein a first local oscillator signal comprises a phase shift of substantially +45 degree and a second local oscillator signal comprises a phase shift of substantially −45 degree with respect to a third local oscillator signal.

13. A television tuner, comprising:
a low noise amplifier configured to amplify a received signal applied to an input terminal;
an up-down frequency converter connected to the low noise amplifier and configured to convert the amplified received signal to a baseband signal, wherein the up-down frequency converter comprises a first mixer stage configured to up-convert the amplified received signal and a second mixer stage to down-convert the up-converted signal, wherein at least one of the first and second mixer stages comprises a harmonic rejection mixer configured to suppress harmonic portions in a local oscillator signal applied thereto.

14. The television tuner of claim 13, wherein at least one of the first and second mixer stages of the up-down frequency converter comprises an image rejection mixer.

15. The television tuner of claim 13, wherein the up-down frequency converter further comprises a bandpass filter arranged between the first mixer stage and the second mixer stage, wherein the bandpass filter comprises a pass-band in the frequency range of the up-converted signal.

16. The television tuner of claim 13, further comprising:
a first signal source configured to provide a first local oscillator signal having an adjustable frequency to the first mixer stage; and
a second signal source configured to provide a second local oscillator signal to the second mixer stage.

17. The television tuner of claim 13, further comprising a signal source coupled to the mixer stage that comprises the harmonic rejection mixer, wherein the signal source is configured to provide three local oscillator signals to the harmonic rejection mixer, a first signal of the three local oscillator signals comprising a phase shift of substantially +45° with respect to a second signal of the three local oscillator signals, and a third signal of the three local oscillator signals comprising a phase shift of substantially −45° with respect to the second signal.

18. The television tuner of claim 13, wherein the first mixer stage comprises a harmonic rejection mixer and the second mixer stage comprises and IQ-demodulator, wherein the second mixer stage comprises an IQ-demodulator having a first mixer and a second mixer, each of the first and second mixer comprising an harmonic rejection behavior.

19. The television tuner of claim 13, further comprising:
a bandpass filter connected downstream of the second mixer stage, wherein the bandpass filter comprises a pass-band center frequency in the range of the signal provided by the second mixer stage.

20. An integrated tuner configured to receive an RF signal, comprising:
an input device configured to receive and amplify an RF signal;
a first frequency conversion means coupled to the input device, and configured to convert the amplified RF signal to an intermediate signal at a first intermediate frequency; and
a second frequency conversion means configured to convert the intermediate signal to a baseband signal at a second intermediate frequency;
wherein at least one frequency conversion means of the first and the second frequency conversion means are configured to suppress harmonic portions with respect to a basic frequency in a signal applied thereto.

21. The integrated tuner of claim 20, further comprising:
filter means arranged between the first frequency conversion means and the second frequency conversion means, wherein the filter means comprises a pass-band center frequency at the first intermediate frequency.

22. A method of processing a television signal, comprising:
receiving the television signal;
providing a first local oscillator signal with an adjustable frequency;
up-converting the received television signal to a first intermediate signal at a first intermediate frequency;
filtering the first intermediate signal to suppress undesired signals portions generated during up-conversion;
down-converting the first intermediate signal to a second intermediate signal at a second intermediate frequency; and
suppressing harmonic signal portions during converting to at least one signal of the first and second intermediate signals.

23. The method of claim 22, wherein up-converting the first intermediate signal comprises providing a second local oscillator signal with the first intermediate frequency.

24. The method of claim 22, wherein providing the first local oscillator signal comprises:
providing a first signal having the adjustable frequency;
providing a second signal having the adjustable frequency and a phase shift of substantially −45° with respect to the first signal; and
providing a third signal having the adjustable frequency and a phase shift of substantially +45° with respect to the first signal.

25. The method of claim 24, wherein suppressing the harmonic signal portions comprises:
amplifying the at least one signal by a factor of approximately 1.41;
converting the amplified signal with the first signal;
converting the at least one signal with the second signal;
converting the at least one signal with the third signal; and
summing together all the converted signals.
